(19) United States
(12) Patent Application Publication
(10) Pub. No.: US 2021/0329727 A1
(43) Pub. Date: Oct. 21, 2021

(54) METHOD AND SYSTEM FOR DEVICE AND SERVER COMMUNICATION

(71) Applicant: Chengfu Yu, Irvine, CA (US)

(72) Inventor: Chengfu Yu, Irvine, CA (US)

(21) Appl. No.: 16/849,105

(22) Filed: Apr. 15, 2020

(51) Int. Cl. H04W 76/25; H04W 24/08; H04W 52/02; H04W 24/04

(52) U.S. Cl. CPC H04W 76/25; H04W 24/04; H04W 52/0258; H04W 24/08

(57) ABSTRACT

A device comprising a network module communicably coupling the device to one or more network access points, a server communicably coupled to the device through the one or more network access points, one or more processors performing operations comprising: receiving one or more keep-alive requests from the one or more network access points, the keep-alive request comprising at least one of: a timeout parameter, a header, a connection parameter, a transmission attribute, a message, and a keep-alive interval; extracting an information from the keep-alive request, the information comprising connection policies for establishing a keep-alive connection between: device and network access point, device and server, or device and a wireless user device communicably coupled to the network access point; determining the keep-alive connection parameters based on the extracted information; and assigning the keep-alive connection as the active connection between the device and the network access point, server, or wireless user device.

### CROSS-REFERENCE TO RELATED APPLICATIONS

The entire contents of the following applications are incorporated herein by reference: U.S. Pat. No. 10,412,346; filed on Mar. 9, 2017; and entitled DUAL VIDEO SIGNAL MONITORING AND MANAGEMENT OF A PERSONAL INTERNET PROTOCOL SURVEILLANCE CAMERA. U.S. Nonprovisional patent application Ser. No. 15/488,211 filed on Apr. 14, 2017; and entitled AN INTERACTIVE AUGMENTED-REALITY IoT DEVICES SYSTEMS AND METHODS. U.S. Pat. No. 9,879,466 filed on Apr. 18, 2017; and entitled GARAGE DOOR CONTROLLER AND MONITORING SYSTEM AND METHOD. U.S. Pat. No. 10,380,854 filed on Nov. 20, 2017; and entitled AUTOMATED SMART DOORBELL DEVICE AND METHOD. U.S. Pat. No. 10,030,885 filed on Jun. 12, 2017; and entitled SMART REGISTER DEVICE AND METHOD. U.S. Nonprovisional patent application Ser. No. 15/888,425 filed on Feb. 5, 2018; and entitled SMART PANEL DEVICE AND METHOD. U.S. Nonprovisional patent application Ser. No. 15/944,696 filed on Apr. 3, 2018; and entitled SMART TRACKER DEVICE AND METHOD. U.S. Nonprovisional patent application Ser. No. 16/056,276 filed on Aug. 6, 2018; and entitled SMART CAM DEVICE AND METHOD. U.S. Pat. No. 10,582,130 filed on Dec. 13, 2018; and entitled SYSTEM AND METHOD FOR CONNECTING A NETWORK CAMERA. U.S. Nonprovisional patent application Ser. No. 16/372,053 filed on Apr. 1, 2019; and entitled SMART ACTIVE CAMERA DEVICE AND METHOD. U.S. Nonprovisional patent application Ser. No. 16/418,998 filed on May 21, 2019; and entitled ACCESS VERIFICATION DEVICE AND METHOD. U.S. Nonprovisional patent application Ser. No. 16/506,965 filed on Jul. 9, 2019; and entitled SMART LOCK DEVICE AND METHOD. U.S. Nonprovisional patent application Ser. No. 16/569,638 filed on Sep. 12, 2019; and entitled SYSTEM AND METHOD FOR LOCATION BASED ANALYSIS TO OPERATE A DEVICE OR APPARATUS. U.S. Nonprovisional patent application Ser. No. 16/778,858 filed on Jan. 31, 2020; and entitled GARAGE DOOR CONTROLLER AND MONITORING SYSTEM AND METHOD.

### FIELD

The present disclosure generally relates to server and device status communication, more particularly monitoring status requests by a server in communication with a device and monitoring status replies by the device in communication with the server.

### BACKGROUND

In current network environments, and for security reasons, most devices on the network do not have a public address and therefore cannot be discovered by others outside the network. The result is a device on the network can send messages to others outside the network environment, but the device cannot hear their reply. What this means in practice is a device can send messages to a server, but the server cannot send messages to the device. Generally, the device or terminal device (e.g. router) communicates the device status to the server by sending messages through a keep-alive protocol. Similarly, the server communicates its status by replying to device messages through the keep-alive protocol. Once a message is received by the server, the server becomes aware of the active status of the device or terminal device, and vice versa.

Regardless of the network environment, the device and server need to consistently be in communication with one another through the keep-alive protocol. The device needs to receive an active/online status from the server and the server needs to receive an active/online status from the device. In general, for server to device communication over extended periods of time, the device will use substantial resources (e.g. CPU time, power usage, etc.,) to notify its active status to the server. For portable devices, extended periods of server to device communication through the keep-active protocol can substantially reduce device resources and significantly reduce battery life. Moreover, IoT devices for example, have limited capabilities for user configuration through a peripheral, as keyboards and other input devices are not always available for user input. Therefore, users generally do not have a quick and easy means of managing or configuring their IoT device for server to device communication or other IoT resource utilization. Thus, there is a need for systems and methods that improve device resource utilization for server to device communications.

### SUMMARY

The disclosed subject matter relates to a device comprising: a network module; the network module capable of communicably coupling to one or more network access points; a server; the server communicably coupled to the device through the one or more network access points; one or more processors; a machine-readable medium comprising instructions stored therein, which, when executed by the one or more processors cause the one or more processors to perform operations comprising: receiving one or more keep-alive requests from the one or more network access points, wherein the keep-alive request comprises at least one of: a timeout parameter, a header, a connection parameter, a transmission attribute, a message, and a keep-alive interval; extracting an information from the keep-alive request, wherein the information comprises connection policies for establishing a keep-alive connection between the device and the network access point, between the device and the server, or between the device and a wireless user device communicably coupled to the network access point; determining the keep-alive connection parameters based on the extracted information; and assigning the keep-alive connection as the active connection between the device and the network access point, server, or wireless user device.

The disclosed subject matter further relates to a method comprising: communicably coupling a server to a device through one or more network access points; receiving one or more keep-alive requests from the one or more network access points, wherein the keep-alive request comprises at least one of: a timeout parameter, a header, a connection parameter, a transmission attribute, a message, and a keep-alive interval; extracting an information from the keep-alive request, wherein the information comprises connection policies for establishing a keep-alive connection between the device and the network access point, between the device and the server, or between the device and a wireless user device communicably coupled to the network access point; determining the keep-alive connection parameters based on the extracted information; and assigning the keep-alive connection as the active connection between the device and the network access point, server, or wireless user device.

The disclosed subject matter further relates to a non-transitory machine-readable medium comprising instructions stored therein, which, when executed by one or more processors of a processing system cause the one or more processors to perform operations comprising: communicably coupling a server to a device through one or more network access points; receiving one or more keep-alive requests from the one or more network access points, wherein the keep-alive request comprises at least one of: a timeout parameter, a header, a connection parameter, a transmission attribute, a message, and a keep-alive interval; extracting an information from the keep-alive request, wherein the information comprises connection policies for establishing a keep-alive connection between the device and the network access point, between the device and the server, or between the device and a wireless user device communicably coupled to the network access point; determining the keep-alive connection parameters based on the extracted information; and assigning the keep-alive connection as the active connection between the device and the network access point, server, or wireless user device.

It is understood that other configurations of the present disclosure will become readily apparent to those skilled in the art from the following detailed description, wherein various configurations of the present disclosure are shown and described by way of illustration. As will be realized, the present disclosure of other different configurations and its several details are capable of modifications in various other respects, all without departing from the subject technology. Accordingly, the drawings and the detailed description are to be regarded as illustrative in nature and not restrictive.

### BRIEF DESCRIPTION OF THE DRAWINGS

Certain features of the present disclosure are set forth in the appended claims. However, for purpose of explanation, several implementations of the present disclosure are set forth in the following figures.

FIG. 1 illustrates an exemplary network environment for implementing a server to device communication system in accordance with one or more embodiments of the present disclosure.

FIGS. 2A-2B illustrate an exemplary embodiment of server to device keep-alive communication system in accordance with one or more embodiments of the present disclosure.

FIG. 2C illustrates an exemplary embodiment of server to device keep-alive communication system in accordance with one or more embodiments of the present disclosure.

FIG. 3 illustrates an exemplary embodiment of the device to server communication system communicating with other smart or wireless electronic devices in accordance with one or more embodiments of the present disclosure.

FIGS. 4A-4D illustrate an exemplary embodiment of a flowchart of device to server communication system in accordance with one or more embodiments of the present disclosure.

Embodiments of the present disclosure and their advantages are best understood by referring to the detailed description that follows. It should be appreciated that like-reference-numerals are used to identify like-elements illustrated in one or more of the figures.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Various features of the present disclosure will now be described and is not intended to be limited to the embodiments shown herein. Modifications to these features and embodiments will be readily apparent to those skilled in the art, and the principles defined herein may be applied to other embodiments without departing from the scope of the disclosure.

As mentioned above, server to device keep-alive communication over extended periods of time uses substantial device resources to consistently request and maintain keep-alive status with a server. For portable devices, extended periods of server to device communication through the keep-active protocol can substantially reduce device resources and significantly reduce battery life. Based on our research, power consumption can be greatly reduced by reversing the role of server and device in keep-alive communications. As shown in Table 1.0, most CPUs and chipsets consume more energy to transmit (send a request) than to receive (receive a request). For example, for battery operated portable devices having chipset model: CYW43438, transmitting a request @ 15 dBm consumes 260 mA from the device, while receiving a request consumes 40 mA from the device. The transmit power consumption is 6.5× more than receive power consumption.

TABLE 1.0

| | device communication types | | | | |
|---|---|---|---|---|---|
| | Wi-Fi | Wi-Fi | Wi-Fi | 2.4 GHz | 2.4 GHz |
| | device chipset model | | | | |
| | CYW43438 | Hi11315 | CC3200 | A7190 | A7131 |
| | | Power consumption (mA) | | | |
| Receive a request | 40 | 45 | 59 | 28 | 27 |
| Transmit a request | | | | | 25 |
| @10 dBm | | | | | |
| Transmit a request | 260 | | 229 | | |
| @15 dBm | | | | | |
| Transmit a request | | | | 120 | |
| @17 dBm | | | | | |
| Transmit a request | 290 | 270 | | | |
| @18 dBm | | | | | |
| Transmit a request | 320 | | | 183 | |
| @20 dBm | | | | | |
| Transmit a request | | 352 | | | |
| @22 dBm | | | | | |

By reducing the number of device-to-server transmissions, device power consumption will be greatly reduced. In some exemplary embodiments, device power consumption is reduced by reversing the roles of server and device for keep-alive communications. In some exemplary embodiments, device power consumption may be further reduced by limiting the number of device keep-alive transmissions to only when the server queries a keep-alive status from the device. Thus, device power consumption is greatly reduced by using a process of reverse hopping and server-to-device status queries. The server will continue to send hop packets, and the device will continue to receive hop packets without any reply transmissions. The device will only transmit replies when it receives a query from the server.

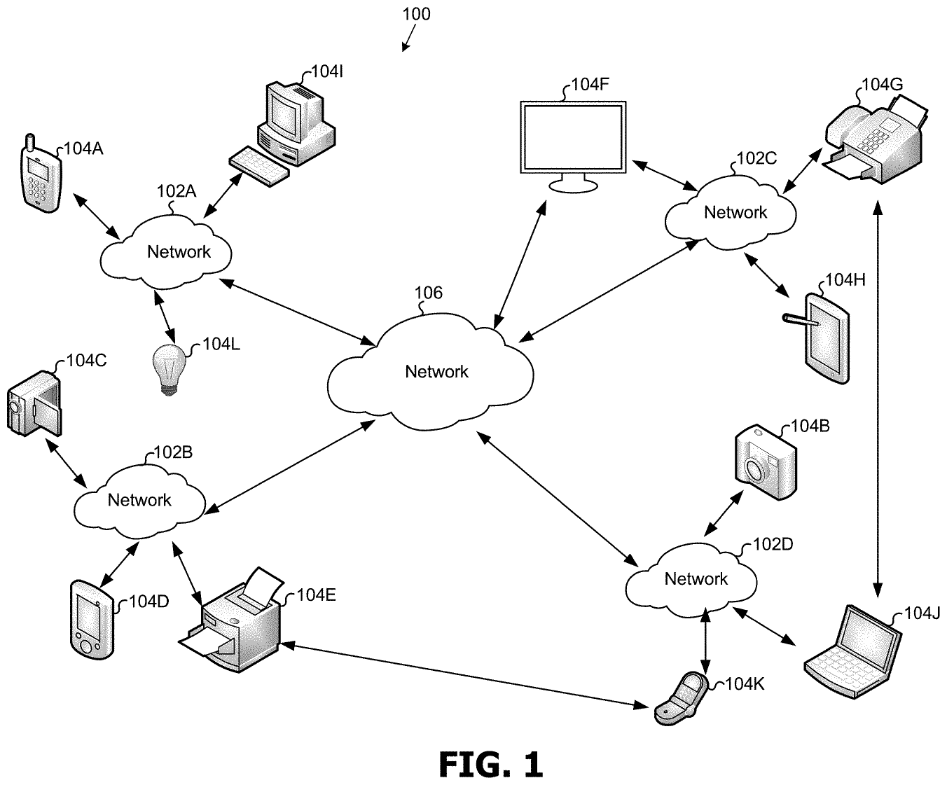

FIG. 1 illustrates an exemplary network environment 100 for implementing a reverse keep-alive communication system in accordance with one or more embodiments of the present disclosure. Not all depicted components may be required. However, one or more implementations may require additional components, fewer components or different components not shown in network environment 100. Thus, any variations in network environment 100 may be implemented without departing from the scope of the present disclosure. The exemplary network environment 100 comprises of one or more exemplary devices that may be communicably coupled to one or more servers for implementing keep-alive communication system.

Network environment 100 may be a number of networks such as an IoT network, a private network, the internet, any other network, or combinations thereof. The network environment 100 includes networks 102A, 102B, 102C, 102D (hereafter referred to as 102A-102D) and 106. Network environment 100 includes a number of electronic devices 104A, 104B, 104C, 104D, 104E, 104F, 104G, 104H, 104I, 104J, 104K, 104L (hereafter referred to as 104A-104L). One or more of the devices 104A-104L, such as device 104A, may be a device capable of communicating with one or more of devices 104A-104L (e.g., via wired or wireless communication). In some aspects, the devices 104A-104L may include, may be embedded in, or may be coupled to a portable communication device, such as a mobile phone, a laptop, a tablet or any other communication device. The devices 104A-104L may be communicably coupled to one or more of the networks 102A-102D, 106 and/or to one or more other devices of the devices 104A-104L. As depicted in FIG. 1 examples of devices 104A-104L may include a computer, a desktop, a laptop, a tablet, a fax machine, a smart home device, an IoT device, a printer, light bulb and so forth.

One or more of the networks 102A-102D and 106 include one or more wired or wireless devices that facilitate devices communication, such as router devices, switch devices, relay devices, etc., and/or include one or more servers. One or more of the networks 102A-102D and 106, such as network 106 may be, or may include, a cloud of computers. One or more of the networks 102A-102D and 106 may be a local area network that communicatively couples one or more of the devices 104A-104L. In one or more implementations, one or more of networks 102A-102D and 106 may be referred to as an IoT network and/or a machine-to-machine (M2M) network.

One or more of the devices 104A-104L may be referred to as an IoT device and/or an M2M device and may include human-machine interface (HMI) applications and machine-interface applications. There may be multiple paths between one or more of the devices 104A-104L and/or one or more of the networks 102A-102D and 106. In one or more implementations, devices 104A-104L may utilize a peer-to-peer (P2P) network to establish a communication channel between the devices. One or more of the devices 104A-104L may include or may be a sensor that measures a physical quantity from surrounding environment and convert physical quantities into a signal. Examples of sensors include, by way of illustration only and not by way of limitation, temperature sensors, video cameras, audio recorders, motion sensors, humidity sensors, smoke detectors and other sensors.

In one or more implementations, devices 104A-104L may include one or more of active devices, passive devices and/or implemented wholly or partially as system on chip devices. Devices 104A-104L may include a transmitter, a receiver, a Global Positioning System (GPS), a Bluetooth (BT)/BLE transceiver and/or a WiFi™ transceiver. In one or more implementations, networks 102A-102D and 106 may include one or more network access points, such as a wireless access point (WAP) where the WAP is capable of transmitting a user datagram packet (UDP) and/or Transmission Control Protocol (TCP) packet, where networks 102A-102D and 106 do not need to have a pre-established network connection with receiving devices to transmit the UDP and/or TCP packet. In some aspects, the WAP is also capable of transmitting beacon signals to aid nearby devices (e.g., devices 104A-104L) in detecting the WAP. In some aspects of the technology, one or more of the devices 104A-104L are configured to connect to a wireless access point such as 102A-102D to join a local area network such as local area network utilizing Danale Inc. SMARTADD™ technology.

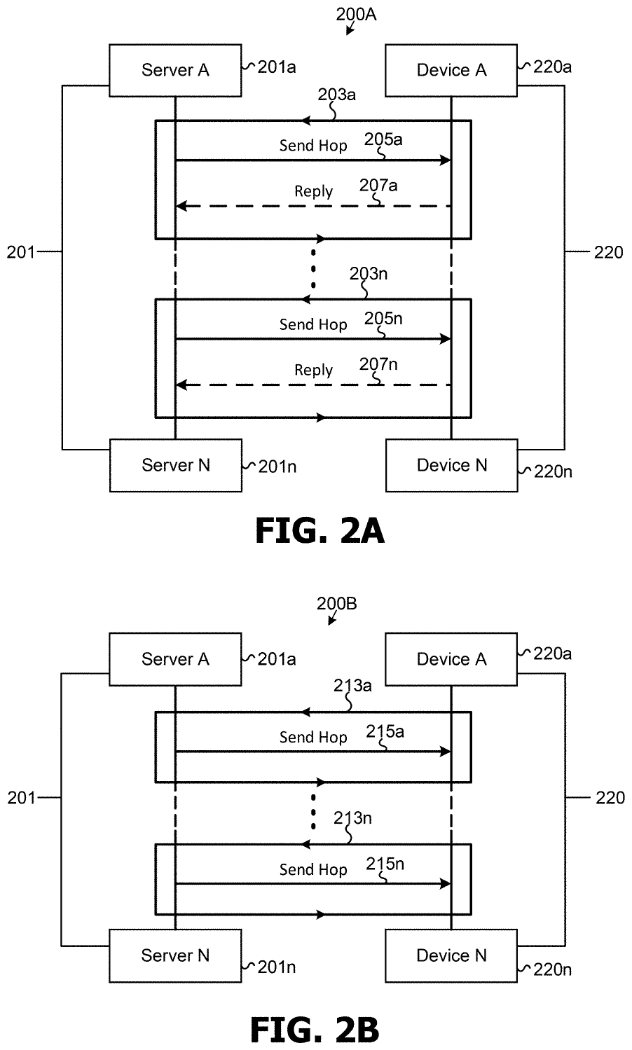

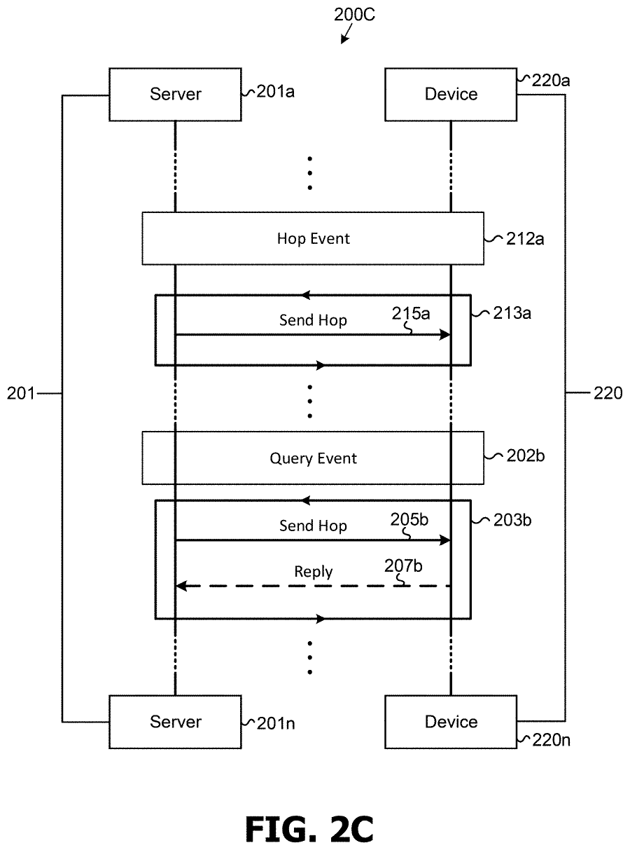

FIG. 2A illustrates an exemplary server to device keep-alive communication system 200A in accordance with one or more embodiments of the present disclosure. In reverse keep-alive communication system 200A, reverse keep-alive handshaking connections 203a . . . 203n may be initiated and maintained by one or more sources or servers 201a . . . 201n. One or more reverse keep-alive connections 203a, 203b, 203c . . . 203n (hereinafter connections 203) are kept open through a plurality of server transactions 201a, 201b, 201c . . . 201n (hereinafter server transactions 201x) and device transactions 220a, 220b, 220c . . . 220n (hereinafter device transactions 220x). The connection 203 is kept open when each server transaction 201x is followed by corresponding device transaction 220x. For example, connection 203a comprises of one or more servers 201 communicating keep-alive connection request header 205a to device 220 and receiving from device 220 connection request header response or reply 207a, and so forth. The reverse keep-alive connection 203 may be subsequently kept active through a plurality of server-initiated transactions 201x of requests 205b-205n to device 220 and device-initiated transactions 220x of replies 207b-207n to server 201.

The reverse keep-alive connections 203 may include one server 201 to one device 220 connection (1:1 transactions), many servers 201a-201n to one device 220 connections (N:1 transactions), one server 201 to many devices 220a-220n connections (1:N transactions), or many servers 201a-201n to many device 220a-220n connections (N:N transactions), or any combination of the above. The connection(s) 203 may be kept alive by one or more server 201 to device 220 communications, for example, one or more server-to-client reverse keep-alive request headers 205a, 205b, 205c . . . 205n (hereinafter requests 205). The device 220 then replies 207a, 207b, 207c . . . 207n to server requests 205 to acknowledge the keep-alive connection request and maintain the keep-alive connection.

When device 220 does not receive keep-alive request 205 from server 201, device 220 may close connection 203. Similarly, when server 201 does not send keep-alive request 205 to device 220, device 220 may try reconnecting to server 201, close connection to server 201, or search for another server 201. Moreover, when server 201 communication does not have keep-alive header 205, device 220 may assume server 201 does not support, or does not intend to maintain, keep-alive communication and the device 220 may close connection 203 upon sending reply 207 message. Further, device 220 or server 201 may close connection 203 at any time to free up resources or limit the number of server transactions 201x or device transactions 220x.

As shown in FIG. 2A, reverse keep-alive communication system 200A uses server-initiated transactions 201x for keep-alive handshaking requests 205a . . . 205n. Using server transactions 201x to maintain keep-alive connections 203 reduces connection resources allocated by device 220 to initiate and maintain keep-alive connections thereby reducing power consumption on device 220. Over extended periods of time, power consumption of device 220 for maintaining server to device connections may be significantly reduced using the reverse keep-alive communications 213 of reverse keep-alive communication system 200A. Moreover, server 201 may close connection 203 or reduce keep-alive connection 203 frequency to further free up device 220 resources.

The reverse keep-alive behavior, restrictions, and rules, for example timeout parameter, close header, max parameter, and other attributes, header fields, and settings may be tuned and managed by server 201. The reverse keep-alive communication system 200A may apply to various wired and wireless networks under IEEE 802, for example, Internet communication standards and protocols; Transmission Control Protocol (TCP), User Datagram Protocol (UDP), HyperText Transfer Protocol (HTTP). The reverse keep-alive communication system 200A may be used in various connections, including, but not limited to, parallel connections, persistent connections, pipelined connections, and multiplexed connections.

FIG. 2B illustrates an exemplary server to device keep-alive communication system 200B in accordance with one or more embodiments of the present disclosure. In reverse keep-alive communication system 200B, server only reverse keep-alive communications 213a . . . 213n may be initiated and maintained by one or more sources or servers 201a . . . 201n. One or more server only reverse keep-alive communications 213a, 213b, 213c . . . 213n (hereinafter communication 213) are kept open through a plurality of server transactions 201x. Each server only reverse keep-alive communication 213 comprises of a reverse keep-alive request header 215a, 215b, 215c . . . 215n (hereinafter request 215) to device 220.

The server-initiated transactions 201x to device 220 include one or more reverse keep-alive requests 215 through connection 213 that inform device 220 of the active status of server 201. The reverse keep-alive communication system 200B may be a unidirectional keep-alive communication from server 201 to device 220. The device 220 receives reverse keep-alive requests 215 and knows server 201 is active, however, server 201 does not receive keep-alive replies and may not know device 220 is active and receiving keep-alive requests 215. As shown in FIG. 2C, server communications may include: one or more server only reverse keep-alive communications 213 having a keep-alive request 215 to confirm the active status of the server 201, and one or more reverse keep-alive connections 203 to confirm the active status of the device 220.

As shown in FIG. 2B, by eliminating device replies 207a-207n responsive to server requests 205a-205n, server only reverse keep-alive communications 213 maintain keep-alive status between device 220 and server 201 while reducing keep-alive processing and connection resources allocated by device 220. Over extended periods of time, power usage for device 220 may be significantly reduced while maintaining a server to device connection using reverse keep-alive communications 213 of reverse keep-alive communication system 200B.

FIG. 2C illustrates an exemplary server to device keep-alive communication system 200C in accordance with one or more embodiments of the present disclosure. The keep-alive communication system 200C comprises of one or more Hop Events 212a, 212b, 212c . . . 212n (hereinafter Hop Events 212) to inform device 220 of the active status of server 201. Each Hop Event 212 comprises of a server transaction 201x to device 220. The server transaction 201x opens the keep-alive connection(s) 213 with device 220, the server 201 communicates one or more reverse keep-alive requests 205 to device 220.

The keep-alive communication system 200C further comprises of one or more Query Events 202a, 202b, 202c . . . 202n (hereinafter Query Events 202) to inform server 201 of the active status of device 220. Each Query Event 202 comprises of a server transaction 201x to device 220 and a device transaction 220x to server 201. The server transaction 201x opens or maintains the keep-alive connection(s) 203 with device 220, the server 201 communicates one or more reverse keep-alive requests 205 to device 220. The request 205 to device 220 is followed by device transaction 220x to server 201, the device 220 communicates one or more reverse keep-alive replies 207 to the server 201.

The keep-alive communication system 200C comprises of Hop Events 212 to maintain active server status on the device 220, and Query Events 202 to maintain active device status on the server 201. In the Query Event 202b, the device 220 replies 207b to server request 205b to acknowledge the keep-alive connection request and maintain the keep-alive connection. The keep-alive connection may be subsequently kept active through a plurality of server-initiated transactions 201x of requests 205b-205n to device 220 and device-initiated transactions 220x of replies 207b-207n to server 201.

Thus, the keep-alive communication system 200C uses server only Hop Events 212, or reverse keep-alive communications 213, to reduce transmit power consumption of device 220, and device Query Events 202 to limit keep-alive reply 207 for device 220 only when needed by server 201. In some exemplary embodiments, server transactions 201x may substantially comprise of Hop Events 212 to further reduce power consumption on device 220 and maintain server active status on device 220. Furthermore, device transactions 220x indicating keep-alive status are reduced as needed to Query Events 202. The server 201 may periodically make a request 205 for a device reply 207 to confirm the active status of device 220.

The keep-alive connection request 205 may include one or more headers comprising of a hop-by-hop header that informs device 220 about connection management policies. For example, request 205 may include one or more parameters defining idle connection timeout, close header, max parameter, header fields, and other attributes and settings that may be optimized and managed by server 201 based on connectivity, device usage, or user preferences. Moreover, the values for the one or more parameters may be set based on policy implemented by servers 201, clients (e.g. devices 220) and intermediaries. Values might also be set based on knowledge that a host has about lower layer intermediaries in the path of the request, such as a TCP middlebox. Such middleboxes, in particular network address translators (NATs), frequently discard mappings for idle connections, causing the connection to fail after a certain duration of inactivity. As a hop-by-hop header, this header may apply to certain connections, for example, single transport-level connections. If a reverse keep-alive header is added to a request or response, the connection header may include the tag keep-alive to ensure compliant intermediaries that do not recognize this header remove it before forwarding a request.

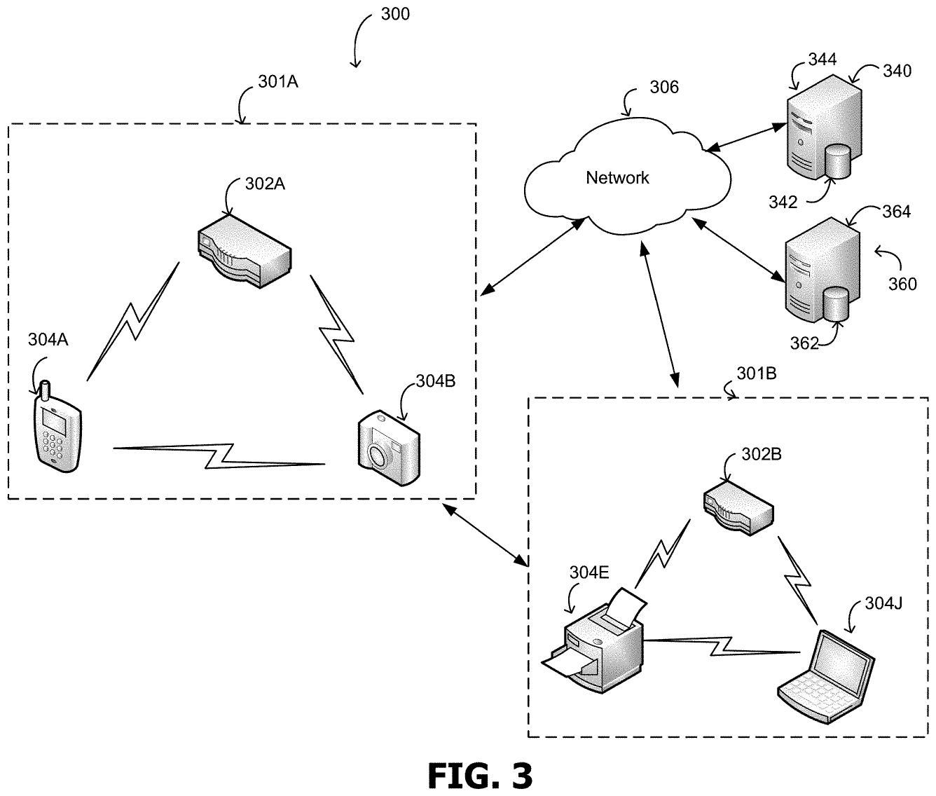

FIG. 3 illustrates an exemplary network environment 300 for implementing the exemplary server to device reverse keep-alive communication system in accordance with one or more embodiments of the present disclosure. The exemplary network environment 300 may include one or more access points 302A and 302B communicably coupling the server to the. Network environment 300 includes wireless local area network 301A, wireless local area network 301B, network 306, and servers 340 and 360. For example, by way of illustration only and not by way of limitation, wireless local area network area 301A may include IoT devices 304A and 304B and wireless access point 302A and wireless local area network area 301B may include IoT devices 304E and 304J and wireless access point 302B. Servers 340 and 360 may include computing devices 344 and 364 and computer-readable storage devices 342 and 362. The network environment 300 includes a wireless access point 302A that facilitates communication between IoT devices 304A and 304B, and wireless access point 302B that facilitates communication between IoT devices 304E and 304J. Nevertheless, devices within local area network 301A such as IoT device 304B might view both local area network 301A and 301B prior to being associated with a specific local area network such as 301A.

In some aspects, network environment 300 may be a distributed client/server system that spans one or more networks such as, for example, network 306. Network 306 may be a large computer network such as, for example, wide area network (WAN), the Internet, a cellular network, or a combination thereof connecting any number of mobile clients, fixed clients, and servers. Further, the network 306 may include, but is not limited to, any of the following network topologies, including a bus network, a star network, a ring network, a mesh network, a star-bus network, tree or hierarchical network, and the like. In some aspects, communication between IoT devices 304A-304B and servers 340 and 360 may occur via a virtual private network (VPN), Secure Shell (SSH) tunnel, or other secure network connection. In some aspects, network 306 may further include a corporate network (e.g., intranet) and one or more wireless access points.

Wireless local area networks 301A-301B may include, but not be limited to, a computer network that covers a limited geographic area (e.g., a home, school, computer laboratory, or office building) using a wireless distribution method (e.g., spread-spectrum or OFDM). Wireless client devices 304A-304B may associate with wireless access point 302A to access wireless local area network 306 using WiFi™ standards (e.g., IEEE 802.11). Wireless access point 302A may include other network components in addition to a wireless access point. For example, wireless access point 302A may include a router, switch, bridge, broadband modem etc. According to aspects of the subject technology, wireless access point 302A is a wireless router that provides both access point functionality and network routing functionality.

Server 340 may be any system or device having a processor, a memory, and communications capability for providing content and/or services to the IoT devices 304A-304B, 304E and 304J. In some example aspects, the server 340 may include a single computing device 344, for example, or may include more than one computing device working together to perform the actions of a server (e.g., cloud computing, server farm). Further, the server 340 may represent various forms of servers including, but not limited to, a web server, an application server, a proxy server, etc.

Similarly, server 360 may be any system or device having a processor, a memory, and communications capability for providing content and/or services to the IoT devices 304A-304B, 304E and 304J. In some example aspects, the server 360 may be a single computing device 364, for example, or may include more than one computing device working together to perform the actions of a server (e.g., cloud computing, server farm). Further, the server 360 may represent various forms of servers including, but not limited to, a web server, an application server, a proxy server, etc.

A cloud-based service may include services provided by one or more servers, such as server 340 and server 360, via one or more networks, such as network 306. Cloud-based services may require authentication of user account credentials for access via a cloud-based application, such as a web-based personal portal, a web-based email application, etc. A cloud-based service has access to computer-readable storage devices 342 and 362 and may store information or data of a user once the user account credentials are authenticated. The stored data or information is also available to the user for future access and possible manipulation via other applications that are employed by the user.

Each of IoT devices 304A-304B, 304E and 304J, may represent various forms of processing devices. By way of illustration only and not by way of limitation, processing devices may include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any of these data processing devices or other data processing devices.

As depicted in FIG. 3, IoT devices 304A-304B, WiFi™ enabled devices, connect and communicate with the wireless access point 302A using wireless links. These wireless links may be established and managed using various protocols including the IEEE 802.11 protocols. The IoT devices 304A-304B may communicate wirelessly through a communication interface (not shown), which may include digital signal processing circuitry. In addition to the IEEE 802.11 protocols, the communication interface may provide for communications under other modes or protocols such as, for example, Global System for Mobile communication (GSM) voice calls, Short Message Service (SMS), Enhanced Messaging Service (EMS) or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, peer-to-peer (P2P) network, or General Packet Radio System (GPRS), among others.

According to aspects of the technology, IoT device 304B is a new device that requires an initial setup process to join wireless local wireless network 302A. Due to limited data entry peripherals, voice messages are communicated to a user, aiding the user during the initial setup process of the IoT device 304B. Upon powering up the IoT device 304B, beacon signals from nearby wireless local area networks (e.g., 302A-302B) are received by IoT device 304B. According to aspects of the subject technology, information contained within the beacon signal is utilized to determine a communication language for IoT device 304B to use in communicating with the user the voice messages.

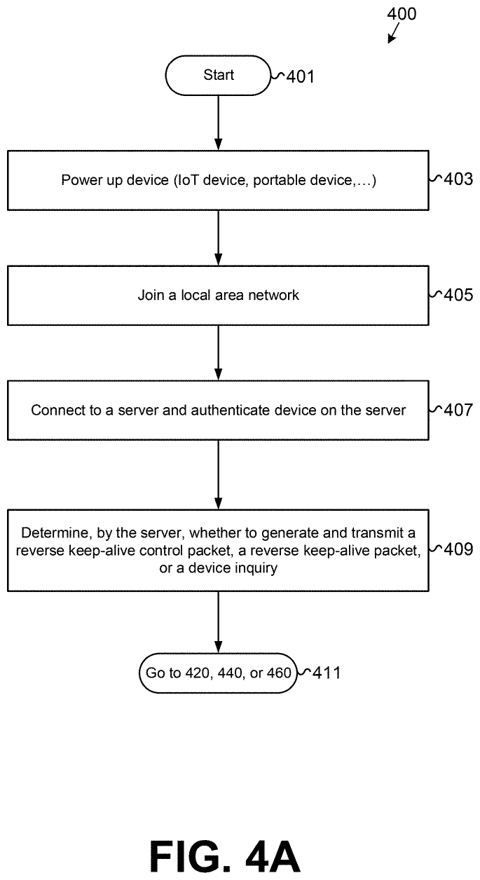

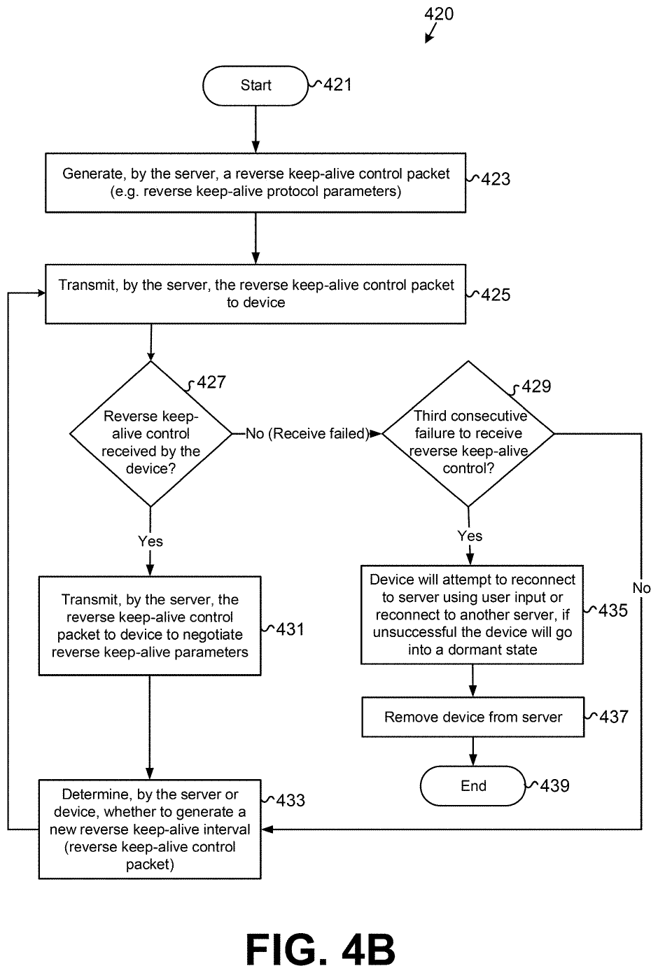

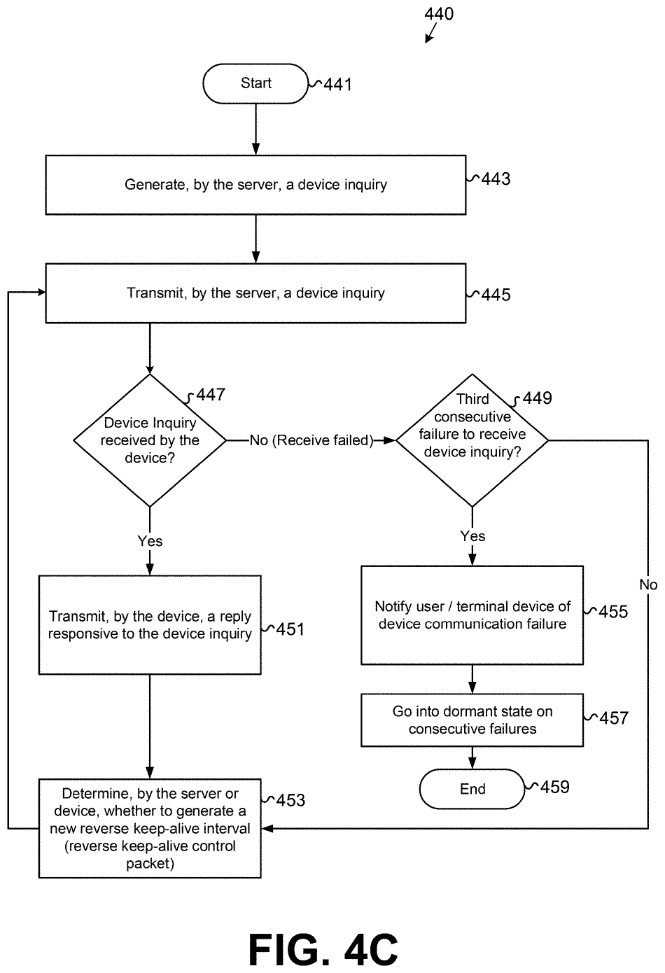

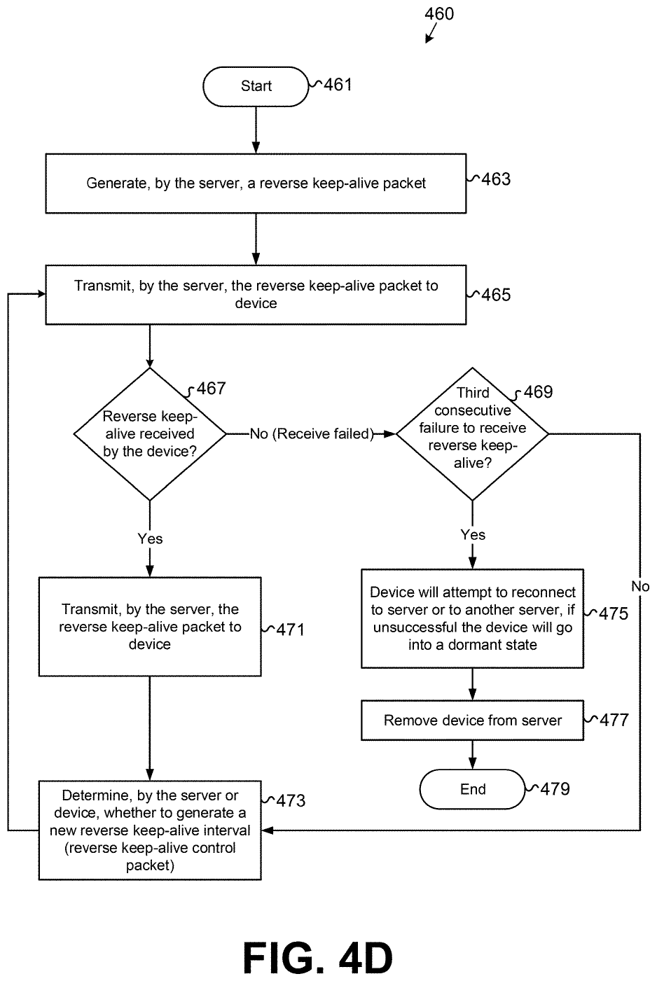

FIGS. 4A-4D illustrate exemplary methods of implementing the reverse keep-alive communication system in accordance with one or more embodiments of the present disclosure. These exemplary methods are provided by way of example, as there are a variety of ways to carry out these methods. Each block shown in FIGS. 4A-4D represents one or more processes, methods or subroutines, carried out in the exemplary method. FIGS. 1, 2A-2C, and 3 show exemplary embodiments of carrying out the methods of FIGS. 4A-4D for establishing, maintaining, or collecting and processing information for reverse keep-alive communication system. Each block shown in FIG. 4A represents one or more processes, methods or subroutines, carried out in the exemplary method. The exemplary method may begin at block 400. Method 400 may be used independently or in combination with other methods or process for reverse keep-alive communication. For explanatory purposes, the example process 400 is described herein with reference to the reverse keep-alive communication system of FIGS. 2A-2C within the exemplary network environment of FIG. 3. Further for explanatory purposes, the blocks of the example process 400 are described herein as occurring in serial, or linearly. However, multiple blocks of the example process 400 may occur in parallel. In addition, the blocks of the example process 400 may be performed a different order than the order shown and/or one or more of the blocks of the example process 400 may not be performed. Further, any or all blocks of example process 400 may further be combined and done in parallel, in order, or out of order.

In FIG. 4A, the exemplary method 400 of implementing the reverse keep-alive communication system is shown. Method 400 begins at block 401. In block 403 of powering up the device (e.g. IoT, portable, or wireless user device) for pairing to an access point. The device may be powered by battery operated or powered by a combination of battery and wired power cable or adapter. In some exemplary embodiments, device may be powered by a power supply. The power from the power supply may be provided by disposable batteries or rechargeable batteries, for example, nickel cadmium (NiCd), lithium (Li), AA, AAA, and/or rechargeable capacitors, for example, supercapacitors (SC) or ultracapacitors. The power supply may supply power to the device by, for example, a power adapter for connecting to an outlet, a solar panels/cell, or any other renewable/alternative power supply source. The device may use multiple battery types, for example, using a coin cell battery to operate some sensor components or to provide auxiliary power.

In block 405, the process continues with connecting the device to a local wireless network. The device may include a network module for connecting to a network of computers or smart devices, a local area network (LAN), a wide area network (WAN), or an Intranet, or a network of networks, for example, the Internet.

In block 407, the device is connected to a server through the local network connection. The device includes a processor that may use the network module to establish and save a single connection or multiple means of connecting to the server (e.g. using WiFi, cellular connection, or by using any IEEE 802.11 standard). Moreover, a remote computing device (e.g. smart phone, smart device, or portable device) may facilitate connection of device to server.

In block 409, the server determines whether to generate and transmit a reverse keep-alive control packet, a reverse keep-alive packet, or a device inquiry. Upon an initial communication between the server and the device, the server may generate a reverse keep-alive control packet and transmit the control packet to the device to establish connection management policies. The keep-alive control packet may include one or more headers comprising of a hop-by-hop header that informs device about connection management policies. For example, the control packet may include one or more parameters defining idle connection timeout, close header, max parameter, header fields, and other attributes and settings that may be optimized and managed by server based on connectivity, device usage, or user preferences. Moreover, the values for the one or more parameters may be set based on policy implemented by servers, clients (e.g. devices) and intermediaries. Values might also be set based on knowledge that a host has about lower layer intermediaries in the path of the request, such as a TCP middlebox. Such middleboxes, in particular network address translators (NATs), frequently discard mappings for idle connections, causing the connection to fail after a certain duration of inactivity. As a hop-by-hop header, this header may apply to certain connections, for example, single transport-level connections. If a reverse keep-alive header is added to a request or response, the connection header may include the tag keep-alive to ensure compliant intermediaries that do not recognize this header remove it before forwarding a request.

The server may be configured to establish connection policies with the device in process 420, request device reverse keep-alive status in process 440, and inform device of server active status in process 460. When device to server connection policies have been established, the server may determine whether to generate and transmit a reverse keep-alive packet to inform the device of the server active status or generate and transmit a device inquiry to obtain the device active status.

Each block shown in FIG. 4B-4D represents one or more processes, methods or subroutines, carried out in the exemplary method. The exemplary method may begin at block 420, 440, or 460. Methods 400, 420, or 460 may be used independently or in combination with other methods or process for reverse keep-alive communication. For explanatory purposes, the example processes 400, 420, and 460 are described herein with reference to the reverse keep-alive communication system of FIGS. 2A-2C within the exemplary network environment of FIG. 3. Further for explanatory purposes, the blocks of the example process 420, 440, and 460 are described herein as occurring in serial, or linearly. However, multiple blocks of the example process 420, 440, or 460 may occur in parallel. In addition, the blocks of the example process 420, 440, or 460 may be performed a different order than the order shown and/or one or more of the blocks of the example process 420, 440, or 460 may not be performed. Further, any or all blocks of example process 420, 440, or 360 may further be combined and done in parallel, in order, or out of order. In any of the above methods, the server or the device may monitor transmission power usage of device at predetermined intervals to determine whether to increase or decrease the frequency of device inquiries or reverse keep-alive requests for a connection status response. As described in Table 1, the transmission power usage of the device for responding to keep-alive requests may be substantially higher than device power usage for receiving the keep keep-alive request. The keep-alive request may include one or more connection or power usage parameters, for example, high, mean, or average transmission power usage. The device may log and monitor transmission power usage, and determined based on the connection or power usage parameters whether to request a new connection policy for reducing power usage. The server may request through one or more device inquiries, transmission power usage information and update connection management policies at predetermined intervals to optimize the device power usage for reverse keep-alive connections. The device and server may monitor frequently for high transmission power usages then optimize the keep-alive requests and device inquiry intervals based on high, mean, or average transmission power usages of the device. The power usage intervals for monitoring power usage may be configured by the device or server to be between about 30 seconds to 1 hour for high transmission power usages of about 300 mA or more, 2 hours to 24 hours for medium transmission power usages of between about 150 mA-280 mA, 24 hours or more for low transmission power usages of about 100 mA or less. The device inquiry frequency and keep-alive requests may subsequently be reduced or increased based on the transmission power usage of the device.

In FIG. 4B, the exemplary method 420 of establishing connection policies with a device for reverse keep-alive communication system is shown. Method 420 begins at block 421, followed by block 423 of generating, by the server, a reverse keep-alive control packet (e.g. keep-alive protocol parameters). In block 425, the reverse keep-alive control packet is transmitted by the server to the device to establish connection management policies. The method 420 may be followed by method 460 or 440, for example, the reverse keep-alive control packet may be sent by the server as a request to update or re-establish connection policies with the device in method 460, the device may acknowledge the keep-alive connection followed by a device inquiry in method 440 to verify the device status as active.

In block 427, the server may attempt, for example, three consecutive requests to establish a keep-alive connection with the device. In block 431, in case the reverse keep-alive connection between server and device is successfully made, the server transmits the reverse keep-alive control packet to device to negotiate keep-alive parameters and establish connection management policies. At any time, the reverse keep-alive connection may be monitored by the server and/or device. In block 433, reverse-keep alive connection status and parameters may be analyzed at predetermined intervals by the server or device to determine whether to generate a new reverse keep-alive interval (reverse keep-alive control packet) or adjust one or more reverse keep-alive parameters.

In the case the reverse keep-alive connection is not made in block 429, the server may attempt, for example, three consecutive requests to establish a keep-alive connection with the device. In block 435, in case the reverse keep-alive connection cannot be made, the device will attempt to reconnect to server through user input or wireless user device input, or attempt to connect to another server, if unsuccessful the device will go into a dormant state. The device will subsequently be removed from the server in block 437, and the method will end in 439.

In FIG. 4C, the exemplary method 440 of inquiring the device status, by the server, in the reverse keep-alive communication system is shown. Method 440 begins at block 441. In block 443, the server generates a device status request packet to inquire the device active status in the reverse keep-alive connection. In block 445, the device status request packet is transmitted by the server to the device to inform device of a device status request. The method 440 may be followed by either method 420 or 460, for example, the reverse keep-alive packet may be sent to the device to establish server active status in method 460, the device or server may acknowledge the keep-alive connection then determine to modify reverse-keep alive parameters based on connection policies or connection status or logs in method 420.

In block 447, the server may attempt, for example, three consecutive device status requests with the device. In block 451, in case the device status request is successfully received, the device transmits a reply responsive to the request to inform the server of the active status of the device. At any time, the reverse keep-alive connection may be monitored by the server and/or device. In block 453, reverse-keep alive connection status and parameters may be analyzed at predetermined intervals by the server or device to determine whether to generate a new reverse keep-alive interval (reverse keep-alive control packet) or adjust one or more reverse keep-alive parameters.

In the case the reverse keep-alive connection is not made in block 449, the server may attempt, for example, three consecutive device status requests with the device. In block 455, in case the device status request cannot be made to, received by, or response obtained from the device, the server may notify the user or wireless user device of device communication failure. In the case, where the device is not able to receive a device inquiry at predetermined intervals based on established connection policies or reverse keep-alive parameters, the device may to reconnect to another server, or request user input or wireless user device input in block 455. Further, in such cases, the device may go into a dormant state and/or subsequently be removed from the server ending the method in block 459.

In FIG. 4D, the exemplary method 460 of sending, by the server, a reverse keep-alive packet to inform the device of the server active status in the reverse keep-alive communication system is shown. Method 460 begins at block 461. In block 463, the server generates a reverse keep-alive packet for sending to the device to maintain a reverse keep-alive connection. In block 465, the reverse keep-alive packet is transmitted by the server to the device to establish or maintain the server active status. The method 460 may be followed by either method 420 or 440, for example, the reverse keep-alive packet may be sent to the device to establish server active status in method 460, the device or server may acknowledge the keep-alive connection then determine to modify reverse-keep alive parameters based on connection policies or connection status or logs in method 420, followed by a device inquiry to verify the device status as active in method 440.

In block 467, the server may attempt, for example, three consecutive requests to establish a keep-alive connection with the device. In block 471, in case the reverse keep-alive connection between server and device is successfully made, the server transmits the reverse keep-alive packet to device to inform the device of the active status of the. At any time, the reverse keep-alive connection may be monitored by the server and/or device. In block 473, reverse-keep alive connection status and parameters may be analyzed at predetermined intervals by the server or device to determine whether to generate a new reverse keep-alive interval (reverse keep-alive control packet) or adjust one or more reverse keep-alive parameters.

In the case the reverse keep-alive connection is not made in block 469, the server may attempt, for example, three consecutive requests to establish a keep-alive connection with the device. In block 475, in case the reverse keep-alive connection cannot be made, the device will attempt to reconnect to server through user input or wireless user device input, or attempt to connect to another server, if unsuccessful the device will go into a dormant state. The device will subsequently be removed from the server in block 477, and the method will end in 479.

A remote computing device may be a smart device, a smart phone, a vehicle, a tablet, a laptop, a TV, or any electronic device capable of wirelessly connecting to a network or joining a wireless network. The remote computing device may be wirelessly and communicably associated to an individual either through a network or server (e.g. through a user account on the server, or WiFi™ login information), or through visual information collected by a smart device or smart home device. The terms individual, wireless communications device, computing device, vehicle, wireless user device, and user may be used interchangeably throughout the present disclosure. A wireless communications device may be used interchangeably with the term computing device, electronic device, or vehicle.

The server may be a computer that provides data to other computers. It may serve data to systems on a local area network (LAN) or a wide area network (WAN) over the Internet. The server may comprise of one or more types of servers (e.g. a web server or file server), each running its own software specific to the purpose of the server for sharing services, data, or files over a network. The server may be any computer configured to act as a server (e.g. a desktop computer, or single or multiple rack-mountable servers) and accessible remotely using remote access software.

The network may be a network of computers, a local area network (LAN), a wide area network (WAN), or an Intranet, or a network of networks, for example, the Internet. Moreover, various interfaces may be used to connect to the network such as cellular interfaces, WiFi™ interfaces, Infrared interfaces, RFID interfaces, ZigBee interfaces, Bluetooth interfaces, Ethernet interfaces, coaxial interfaces, optical interfaces, or generally any communication interface that may be used for device communication. The purpose of the network is to enable the sharing of files and information between multiple systems.

The term “within a proximity”, “a vicinity”, “within a vicinity”, “within a predetermined distance”, and the like may be defined between about 0.01 meters and about 3 meters. The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series and the like.

The term “a predefined distance” may be defined as the distance of an approaching individual as the individual nears one or more network camera system devices, cameras, sensors, or a traceable object used in determining environmental features and/or conditions. The predefined distance may be defined as between about 0.01 meter and about 3 meters.

The terms “predefined” or “predetermined” period of time may be defined to be between about 0.5 second to about 10 minutes.

The processor of the IoT device or smart home device, remoting computing device, or server may perform an action (e.g. first, second, third, etc.) comprising of a single action, set of actions, or a list or blend of actions based on one or more of: a proximity of an individual(s) or remote computing device(s), a time of day, environmental activity and/or environmental features, visual, motion, or audio information, a schedule, user(s) preferences, and the state and settings of entry point devices, the network camera system device, and local electronic devices, as described above. The action may be any one of: locking/unlocking the smart lock, operating smart lights, fully or partially opening one or more garage doors, ringing a digital smart doorbell chime, ringing a manual in-building mechanical or digital doorbell chime, operating a thermostat, smart TV, or other local electronic devices. The action may also include playing a music file, sound file, greeting, or message in response to a detected change in occupancy and/or environmental conditions and/or features, or in response to a detected or defined audio, proximity, visual, or motion trigger. The action may also comprise of controlling other smart devices as communicated through the network camera system device, cameras, sensor modules, remote computing devices, or servers, for example, turning on a ceiling fan, outlet, and communicating with remote computing device(s) or detected individual(s). The action may also comprise of sending an email, text, or SMS to a server, smart devices, or remote computing device(s).

In response to any of the above actions, the action may also comprise of operating, opening, closing or a smart home device or a moveable barrier or object mechanically, electrically, or otherwise communicably coupled to the smart home device to provide for safety, privacy, or security. The server, user, vehicle, computing device, electronic device, smart appliance, or wireless user device may perform any action or series of actions to achieve convenience, safety, security, or privacy for the user, resident, or tenant.

Those of skill in the art will appreciate that the foregoing disclosed systems and functionalities may be designed and configured into computer files (e.g. RTL, GDSII, GERBER, etc.) stored on computer-readable media. Some or all such files may be provided to fabrication handlers who fabricate devices based on such files. Resulting products include semiconductor wafers that are separated into semiconductor dies and packaged into semiconductor chips. The semiconductor chips are then employed in devices, such as, an IoT system, the geofencing system described in FIGS. 4-5, or a combination thereof.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor, and the storage medium may reside as discrete components in a computing device or user terminal.

Further, specific details are given in the description to provide a thorough understanding of the embodiments. However, embodiments may be practiced without these specific details. For example, well-known circuits, processes, algorithms, structures, and techniques have been shown without unnecessary detail to avoid obscuring the embodiments. This description provides example embodiments only and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Where applicable, various embodiments provided by the present disclosure may be implemented using hardware, software, or combinations of hardware and software. In addition, where applicable, the various hardware components and/or software components, set forth herein, may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software or application, in accordance with the present disclosure, such as program code and/or data, may be stored on one or more computer-readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code may be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed:

1. A device comprising:
a network module; the network module capable of communicably coupling to one or more network access points;
a server; the server communicably coupled to the device through the one or more network access points;
one or more processors;
a machine-readable medium comprising instructions stored therein, which, when executed by the one or more processors cause the one or more processors to perform operations comprising:
receiving one or more keep-alive requests from the one or more network access points, wherein the keep-alive request comprises at least one of the following parameters: a timeout parameter, a header, a connection parameter, a transmission attribute, a message, and a keep-alive interval;
extracting an information from the keep-alive request, wherein the information comprises connection policies for establishing a keep-alive connection between the device and the network access point, between the device and the server, or between the device and a wireless user device communicably coupled to the network access point;
determining the keep-alive connection parameters based on the extracted information; and
assigning the keep-alive connection as the active connection between the device and the network access point, server, or wireless user device.

2. The device of claim 1, wherein the server generates the one or more keep-alive request parameters, wherein the one or more keep-alive requests are communicated by the server to the device for informing the device of the active connection status of the server.

3. The device of claim 2, wherein the server generates one or more device inquiries, wherein the one or more device inquiries are communicated by the server to the device for obtaining the active connection status of the device, and wherein upon receiving one or more device inquiries, the device responds to the one or more device inquiries.

4. The device of claim 3, wherein the server analyzes the connection status and parameters at predetermined intervals to determine whether to modify the one or more keep-alive connection parameters and communicate the modified keep-alive connection parameters to the device.

5. The device of claim 3, wherein the device analyzes the connection status and parameters at predetermined intervals to determine whether to notify the server to modify the one or more keep-alive connection parameters.

6. The device of claim 3, wherein at least one of the server or the device monitors transmission power usage of device responses to the one or more device inquiries the device, wherein the keep-alive request parameter includes a request for device transmission power usage information, and wherein the device provides transmission power usage information to the server at predetermined intervals for optimizing keep-alive connection parameters.

7. A method comprising:
communicably coupling a server to a device through one or more network access points;
receiving one or more keep-alive requests from the one or more network access points, wherein the keep-alive request comprises at least one of the following parameters: a timeout parameter, a header, a connection parameter, a transmission attribute, a message, and a keep-alive interval;
extracting an information from the keep-alive request, wherein the information comprises connection policies for establishing a keep-alive connection between the device and the network access point, between the device and the server, or between the device and a wireless user device communicably coupled to the network access point;
determining the keep-alive connection parameters based on the extracted information; and
assigning the keep-alive connection as the active connection between the device and the network access point, server, or wireless user device.

8. The method of claim 7, further comprising generating, by the server, one or more keep-alive request parameters, and communicating the one or more keep-alive requests to the device for informing the device of the active connection status of the server.

9. The method of claim 8, further comprising generating, by the server, one or more device inquiries and communicating the one or more device inquiries to the device for obtaining the active connection status of the device, and wherein upon receiving one or more device inquiries, the device responds to the one or more device inquiries.

10. The method of claim 9, further comprising analyzing, by the server, the connection status and parameters at predetermined intervals to determine whether to modify the one or more keep-alive connection parameters, and communicating the modified keep-alive connection parameters to the device.

11. The method of claim 9, further comprising analyzing, by the device, the connection status and parameters at predetermined intervals and determining whether to notify the server to modify the one or more keep-alive connection parameters.

12. The method of claim 9, further comprising monitoring, by at least one of the server or the device, the transmission power usage of device responses to the one or more device inquiries the device, wherein the keep-alive request parameter includes a request for device transmission power usage information, and wherein the device provides transmission power usage information to the server at predetermined intervals for optimizing keep-alive connection parameters.

13. A non-transitory machine-readable medium comprising instructions stored therein, which, when executed by one or more processors of a processing system cause the one or more processors to perform operations comprising:
communicably coupling a server to a device through one or more network access points;
receiving one or more keep-alive requests from the one or more network access points, wherein the keep-alive request comprises at least one of the following parameters: a timeout parameter, a header, a connection parameter, a transmission attribute, a message, and a keep-alive interval;
extracting an information from the keep-alive request, wherein the information comprises connection policies for establishing a keep-alive connection between the device and the network access point, between the device and the server, or between the device and a wireless user device communicably coupled to the network access point;
determining the keep-alive connection parameters based on the extracted information; and
assigning the keep-alive connection as the active connection between the device and the network access point, server, or wireless user device.

14. The non-transitory machine-readable medium of claim 13, further comprising generating, by the server, one or more keep-alive request parameters, and communicating the one or more keep-alive requests to the device for informing the device of the active connection status of the server.

15. The non-transitory machine-readable medium of claim 14, further comprising generating, by the server, one or more device inquiries and communicating the one or more device inquiries to the device for obtaining the active connection status of the device, and wherein upon receiving one or more device inquiries, the device responds to the one or more device inquiries.

16. The non-transitory machine-readable medium of claim 15, further comprising analyzing, by the server, the connection status and parameters at predetermined intervals to determine whether to modify the one or more keep-alive connection parameters, and communicating the modified keep-alive connection parameters to the device.

17. The non-transitory machine-readable medium of claim 15, further comprising analyzing, by the device, the connection status and parameters at predetermined intervals and determining whether to notify the server to modify the one or more keep-alive connection parameters.

18. The non-transitory machine-readable medium of claim 15, further comprising monitoring, by at least one of the server or the device, the transmission power usage of device responses to the one or more device inquiries the device, wherein the keep-alive request parameter includes a request for device transmission power usage information, and wherein the device provides transmission power usage information to the server at predetermined intervals for optimizing keep-alive connection parameters.
